(19) United States
(12) Patent Application Publication
(10) Pub. No.: US 2025/0224720 A1
(43) Pub. Date: Jul. 10, 2025

(54) METHOD AND APPARATUS WITH TABULAR DATA AUGMENTATION

(71) Applicant: Samsung Electronics Co., Ltd., Suwon-si (KR)

(72) Inventor: Ho-Kuen SHIN, Suwon-si (KR)

(73) Assignee: Samsung Electronics Co., Ltd., Suwon-si (KR)

(21) Appl. No.: 19/009,428

(22) Filed: Jan. 3, 2025

(30) Foreign Application Priority Data
Jan. 5, 2024 (KR) 10-2024-0002497

(51) Int. Cl. G05B 23/02

(52) U.S. Cl. CPC G05B 23/024

(57) ABSTRACT

There are provided a method and apparatus for augmenting a dataset through the steps of determining a correlation between a plurality of vectors included in the dataset, determining perturbation based on the correlation, and generating an augmented dataset by adding the perturbation to the dataset.

### CROSS-REFERENCE TO RELATED APPLICATION

This application claims priority to and the benefit of Korean Patent Application No. 10-2024-0002497 filed in the Korean Intellectual Property Office on Jan. 5, 2024, the entire contents of which are incorporated herein by reference.

### BACKGROUND

### 1. Field

The present disclosure relates to a method and apparatus with tabular data augmentation.

### 2. Description of Related Art

A pair of image or text data, for example, may generally be generated by adding Gaussian random noise or performing overwrite with an arbitrary sample value. This is because, in an image or text domain, same semantic of the original may be predicted from surrounding pixel information or context even if noise is added to the original. In other words, when it is possible to predict a damaged part from surrounding information and the original semantic of data is maintained even if data is damaged by some noise, an appropriate original-augmented pair of the original and augmented data may be generated according to the above method. However, the tabular data may include data of multiple classes, and the data of each class may change class or have completely different semantic with even a very small change in value. Therefore, unlike the image or text domain, augmentation techniques such as the adding or overwriting with arbitrary/random noise may not be effective for augmenting tabular data.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method for augmenting a dataset, performed by one or more processors, includes: determining a correlation between vectors included in the dataset; determining perturbation based on the correlation; and generating an augmented dataset by adding the perturbation to the dataset.

The determining of the correlation between the vectors included in the dataset may include performing principal component analysis (PCA) or independent component analysis (ICA) on the vectors.

The performing of the PCA or ICA on the vectors may include: determining a covariance matrix between column vectors included in the dataset; and calculating an eigenvector and an eigenvalue of the covariance matrix.

The determining of the perturbation based on the correlation may include determining perturbations respectively corresponding to rows of the dataset by scaling each element of the eigenvector using the eigenvalue and a hyperparameter.

The hyperparameter may be independently determined for each row of the dataset by random sampling from a normal distribution.

The generating of the augmented dataset by adding the perturbation to the dataset may include adding the perturbations to the respective rows of the dataset.

The method may further include: converting non-numeric data included in the dataset into numeric data, wherein the vectors include the numeric data.

The determining of the correlation between the vectors included in the dataset may include: receiving a three-dimensional embedding vector generated by mapping data included in the dataset to a latent space; and determining a correlation between vectors included in the three-dimensional embedding vector.

The data included in the dataset may include numeric data and non-numeric data.

The method may further include: storing the augmented dataset in a database or transmitting the stored augmented data to an artificial intelligence (AI) model.

In another general aspect, an apparatus for augmenting a dataset includes: one or more processors and a memory, wherein the memory stores instructions configured to cause the one or more processors to perform a process comprising: determining a correlation between vectors included in the dataset; and generating an augmented dataset by adding perturbation determined based on the correlation to the dataset.

The determining of the correlation between the vectors included in the dataset may include performing principal component analysis (PCA) or independent component analysis (ICA) on the plurality of vectors.

The performing of the PCA or ICA on the vectors may include: determining a covariance matrix between column vectors included in the dataset; and calculating an eigenvector and an eigenvalue of the covariance matrix.

The generating of the augmented dataset by adding the perturbation determined based on the correlation to the dataset may include determining the perturbations respectively corresponding to rows of the dataset by scaling each element of the eigenvector using the eigenvalue and a hyperparameter.

The generating of the augmented dataset by adding the perturbation determined based on the correlation to the dataset may include adding the perturbations to the respective rows of the dataset.

The process may further include: converting non-numeric data included in the dataset into numeric data, wherein the plurality of vectors include the numeric data.

The determining of the correlation between the vectors included in the dataset may include: receiving, from an artificial intelligence (AI) model, a three-dimensional embedding vector generated by mapping the data included in the dataset to a latent space; and determining a correlation between vectors included in the three-dimensional embedding vector.

The data included in the dataset may include both numeric data and non-numeric data.

The process may further include transmitting the augmented dataset to the AI model which performs an inference on the augmented dataset.

In another general aspect, a system for inspecting a semiconductor manufacturing process includes: a sampler that samples a semiconductor wafer for inspection of semiconductor manufacturing process using an artificial intelligence (AI) model; and an inspection device that performs measurement on the semiconductor wafer sampled by the sampler, wherein the AI model is trained through self-supervised learning based on an input pair of an original dataset and a dataset labeled identically to the original dataset.
a method for augmenting a dataset is performed by one or more processors and includes: determining a correlation between vectors included in the dataset; determining perturbation based on the correlation; and generating an augmented dataset by adding the perturbation to the dataset.

In another general aspect, an apparatus for augmenting a dataset includes: one or more processors and a memory, wherein the memory stores instructions configured to cause the one or more processors to perform a process comprising: determining a correlation between vectors included in the dataset; and generating an augmented dataset by adding perturbation determined based on the correlation to the dataset.

In another general aspect, a system for inspecting a semiconductor manufacturing process includes: a sampler configured to sampling a semiconductor wafer for inspection of semiconductor manufacturing process using an artificial intelligence (AI) model; and an inspection device performing measurement on the semiconductor wafer sampled by the sampler, wherein the AI model is trained through self-supervised learning based on an input pair of an original dataset and a dataset labeled identically to the original dataset.

### BRIEF DESCRIPTION OF THE DRAWINGS

FIG. 1 illustrates an apparatus for augmenting data according to one or more embodiments.

FIG. 2 illustrates tabular data according to one or more embodiments.

FIG. 3 illustrates a method for augmenting a dataset according to one or more embodiments.

FIG. 4 illustrates another method for augmenting a dataset according to another embodiment.

FIG. 5 illustrates a system for training an AI model according to one or more embodiments.

FIG. 6 illustrates a system for training an AI model according to another embodiment.

FIG. 7 illustrates a system for inspecting a semiconductor manufacturing process according to one or more embodiments.

FIG. 8 illustrates a neural network according to one or more embodiments.

FIG. 9 illustrates an apparatus for augmenting data according to another embodiment.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION OF THE EMBODIMENTS

Hereinafter, embodiments of the present disclosure will be described in detail with reference to the accompanying drawings so that those skilled in the art to which the present disclosure pertains may easily practice the present disclosure. However, the present disclosure may be implemented in various different forms and is not limited to exemplary embodiments described herein. In addition, components unrelated to a description will be omitted in the accompanying drawings in order to clearly describe the present invention, and similar reference numerals will be used to denote similar components throughout the present specification.

In the present disclosure, each phrase such as “A or B,” “at least one of A and B,” “at least one of A or B,” “A, B, or C,” “at least one of A, B and C,” and “at least one of A, B, or C” may include any one of items listed together in the corresponding one of those phrases, or all possible combinations thereof.

In the present disclosure, unless explicitly described to the contrary, the word “comprise”, and variations such as “comprises” or “comprising”, will be understood to imply the inclusion of stated elements but not the exclusion of any other elements.

In the present disclosure, an expression written in singular may be construed in singular or plural unless an explicit expression such as “one” or “single” is used. In the present disclosure, “and/or” includes each and every combination of one or more of the mentioned items

In the present disclosure, terms including an ordinal number such as first, second, etc., may be used to describe various components, but the components are not limited to these terms. The above terms are used solely for the purpose of distinguishing one component from another. For example, a ‘first’ component may be named a ‘second’ component and the ‘second’ component may also be similarly named the ‘first’ component, without departing from the scope of the present disclosure.

In the present disclosure, in flowcharts described with reference to the drawings, an order of operations may be changed, several operations may be merged, some operations may be divided, and specific operations may not be performed.

An artificial intelligence (AI) model of the present disclosure is a machine learning model that learns at least one task, and may be implemented as a computer program (instructions) executed by a processor. The task learned by the AI model may be solved through machine learning or a task to be performed through machine learning. The AI model may be implemented as the computer program executed on a computing device, downloaded over a network, or sold in the form of a product. Alternatively, the AI model may be linked with various devices through the network.

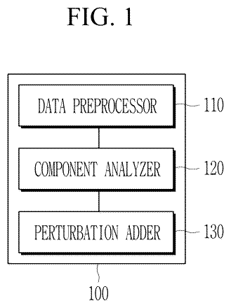

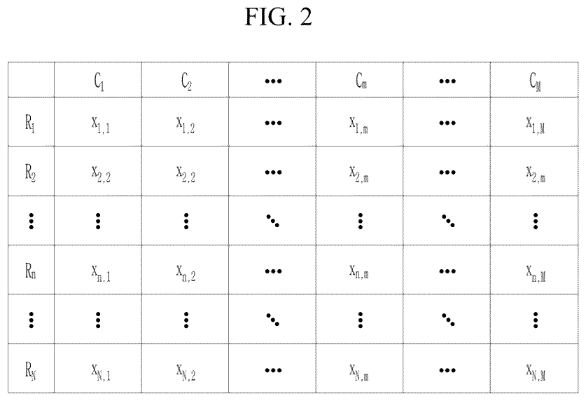

FIG. 1 illustrates an apparatus for augmenting data according to one or more embodiments. FIG. 2 illustrates tabular data according to one or more embodiments.

In some embodiments, an apparatus 100 for augmenting data may receive an original dataset related to a product from an inspection facility, and augment the dataset while maintaining a semantic aspect of the dataset. For example, when the original dataset generated by the inspection facility belongs to a specific class, the augmented dataset may also belong to the same class as the original dataset.

In some embodiments, the original dataset and the augmented dataset may be a tabular dataset. Referring to FIG. 2, FIG. 2 shows the original dataset in the form of a tabular dataset composed of N rows and M columns. The original dataset may include numeric data or categorical data. The original dataset may include non-continuous data such as categorical data and discrete data (for example, integer data).

In some embodiments, when the original dataset is obtained from equipment involved in a semiconductor manufacturing process, each row of the original dataset may represent an instance of the semiconductor manufacturing process (e.g., a production run), and each columnar element in a row may be data generated for the row's manufacturing process instance. In a non-limiting example, each row may contain information specific to a chip, for example, each row may include a lot number of a manufacturing process, an identifier of a wafer, an identifier of the chip within the wafer, etc. In such an embodiment, data in columns may include data such as a critical dimension of a semiconductor, categorical data such as an identifier, or categorical or non-continuous data.

In some embodiments, the original dataset may include sensor data and/or event data that is obtained from fault detection and classification (FDC) and event report data (ERD) that come from monitoring/manufacturing equipment in the semiconductor manufacturing process and that may be used to analyze abnormalities.

The data of each column of the original dataset may constitute a column vector, and the data of each row of the original dataset may constitute a row vector. The apparatus 100 for augmenting a dataset may augment an original dataset by adding perturbation (or noise) to the original dataset on a row-by-row basis or by adding perturbation to the original dataset on a column-by-column basis.

In some embodiments, the AI model may be trained using an augmented dataset that has the same semantic as the original dataset. The augmented dataset, which has the same semantic as the original dataset, may belong to the same class as the original dataset or may be labeled identically to the original dataset. For example, as explained in detail further below, when there is a shortage of data belonging to a specific class (e.g., a specific type of defect), the apparatus 100 for augmenting a dataset may generate a dataset with a large amount of data labeled with the class by augmenting the original dataset (new/updated data may have the same label as the corresponding original data). The AI model may perform supervised learning or self-supervised learning using the original dataset and the augmented dataset that has the same meaning as the original dataset.

In some embodiments, an AI model trained based on the original dataset and the augmented dataset may be applied to various prediction and classification tasks (e.g., virtual metrology, yield prediction, etc.) in the semiconductor manufacturing process. Alternatively, the AI model trained based on the original dataset and augmented dataset may be applied to prediction and classification tasks in the medical and financial fields where various tabular data are used.

Referring to FIG. 1, the apparatus 100 for augmenting a dataset according to one or more embodiments may include a data preprocessor 110, a component analyzer 120, and a perturbation adder 130.

In some embodiments, the data preprocessor 110 may convert non-numeric data included in the original dataset into numeric data, e.g., integers or real numbers.

In some embodiments, the component analyzer 120 may determine a correlation between vectors included in the original dataset. For example, the component analyzer 120 may perform principal component analysis (PCA) or independent component analysis (ICA) on the vectors included in the original dataset to determine correlations between the vectors.

In some embodiments, the component analyzer 120 may determine a covariance matrix (representing inter-vector correlations) between the vectors included in the original dataset through the PCA or ICA and determine eigenvectors and eigenvalues of the covariance matrix. Alternatively, the component analyzer 120 may determine the covariance and/or correlation coefficient between a reference vector and the vectors included in the original dataset.

The component analyzer 120 may determine one of the as the reference vector or may generate the reference vector by performing predetermined statistical processing on the vectors.

In some embodiments, the perturbation adder 130 may determine a perturbation based on the correlation between the vectors in the original dataset and add the determined perturbation to the original dataset to generate the augmented dataset.

For example, the perturbation adder 130 may augment the original dataset by determining the perturbation based on the eigenvector and eigenvalue and adding the determined perturbation to the original dataset. In this case, the perturbation adder 130 may scale each element of the eigenvector using hyperparameters (for tuning the perturbation process) and the eigenvalue and determine the scaled eigenvector as the perturbation. Alternatively, the perturbation adder 130 may determine the perturbation by multiplying the hyperparameters and the covariance and/or correlation coefficient. A hyperparameter may be used to control the overall degree of perturbation, for example.

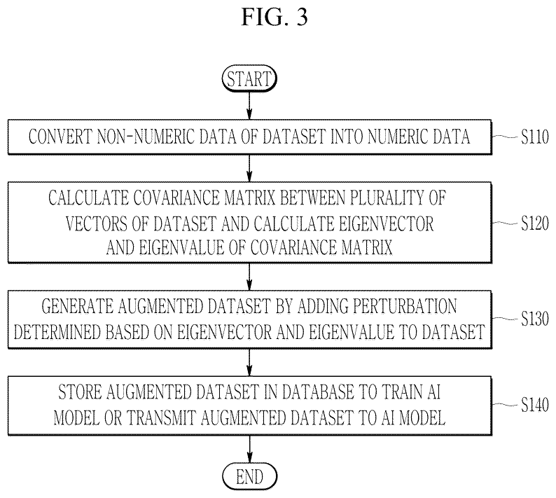

FIG. 3 illustrates a method for augmenting a dataset according to one or more embodiments.

Referring to FIG. 3, the data preprocessor 110 of the apparatus 100 for augmenting a dataset may convert the non-numeric data included in the original dataset into the numeric data (S110). When the original dataset does not include non-numeric data but only numeric data, the original dataset may transparently pass through the data preprocessor 110 (or the data processor 110 may be omitted) and may be provided directly to the component analyzer 120. When the original dataset includes numeric data and non-numeric data, the data preprocessor 110 may selectively convert only the non-numeric data into the numeric data.

Referring to FIG. 3, the component analyzer 120 of the apparatus 100 for augmenting a dataset may determine the covariance matrix between the vectors included in the original dataset, and determine the eigenvector and eigenvalue of the covariance matrix (S120). Column vectors in the original dataset may have different features/vales, and the component analyzer 120 may calculate the covariance matrix between the column vectors in the original dataset.

In some embodiments, an m-th column vector Cₘ of the original dataset having N rows and M columns may be expressed as Equation 1.

$${C}_{m} = {[ {x}_{1 , m} , {x}_{2 , m} , … , {x}_{n , m} , … \cdot {x}_{N , m} ]}^{T} \qquad Equation 1$$

As in Equation 1, the column vector Cₘ of column m of the original dataset is an N-dimensional vector including N data elements. The covariance matrix (M×M matrix) between M column vectors in the original dataset is as shown in Equation 2 below.

$$\sum = ( \begin{matrix}{σ}_{1}^{2} & {σ}_{12} & … & {σ}_{1 M} \\ {σ}_{21} & {σ}_{2}^{2} & … & {σ}_{2 M} \\ ⋮ & ⋮ & ⋱ & ⋮ \\ {σ}_{M 1} & {σ}_{M 2} & … & {σ}_{M}^{2}\end{matrix} ) \qquad Equation 2$$

In Equation 2, for example, σ₁₂ represents a covariance between first and second column vectors C₁ and C₂ of the original dataset. The component analyzer 120 may determine the eigenvector and eigenvalue of the covariance matrix Σ. The eigenvector and eigenvalue of the covariance matrix Σ can be calculated through Equation 3 below. Equation 4 represents the eigenvector ν and eigenvalue λ of the covariance matrix.

$$\sum v = λ v \qquad Equation 3$$

$$v = [ {v}_{1} , … , {v}_{M} ] \qquad Equation 4$$

$$λ = [ {λ}_{1} , … , {λ}_{M} ]$$

In some embodiments, the perturbation adder 130 of the apparatus 100 for augmenting a dataset may determine the perturbation based on the eigenvector and eigenvalue determined through component analysis of the original dataset and add the perturbation to the original dataset (S130).

In some embodiments, the perturbation adder 130 may determine the perturbation corresponding to each row of the original dataset by scaling each element of the eigenvector using the eigenvalue, and add the perturbation to the original dataset on a row-by-row basis to generate the augmented dataset. Equation 5 below represents an n-th row Rₙ′ of the augmented dataset.

$${R}_{n}^{′} = {R}_{n} + {[ {v}_{1} , … , {v}_{M} ] [ {α}_{n} {λ}_{1} , … , {α}_{n} {λ}_{M} ]}^{T} \qquad Equation 5$$

Referring to Equation 5, the perturbation adder 130 may add the eigenvector scaled by the hyperparameter αₙ and eigenvalue as the perturbation to the row vector of the original dataset in order to augment the original dataset.

In some embodiments, the hyperparameter αₙ is a variable that determines the size of the perturbation and may be determined for each row of the dataset, and may be independently determined for each row by random sampling of a normal distribution (mean μ, variance σ²). For example, α₁ for the augmentation of the first row and α₂ for the augmentation of the second row may both be randomly sampled from the same normal distribution, but the sampled values may be different.

Alternatively, the component analyzer 120 of the apparatus 100 for augmenting a dataset may determine a covariance matrix (N×N matrix) based on N row vectors Rₙ of the original dataset, and calculate the eigenvector (N dimension) and eigenvalue of the covariance matrix between N row vectors.

Further regarding the row-oriented covariance approach, the perturbation adder 130 of the apparatus 100 for augmenting data determines the perturbation corresponding to each column of the original dataset based on the eigenvector and eigenvalue determined through the component analysis of the original dataset, and adds the determined perturbation to the original dataset on a column-by-column basis. Equation 6 below represents an m-th column Cₘ′ of the augmented dataset.

$${C}_{m}^{′} = {C}_{m} + {[ {v}_{1} , … , {v}_{N} ] [ {α}_{m} {λ}_{1} , … , {α}_{m} {λ}_{N} ]}^{T} \qquad Equation 6$$

Referring to Equation 6, the perturbation adder 130 may add the eigenvector scaled by the hyperparameter αₘ and eigenvalue as the perturbation to each column of the original dataset in order to augment the original dataset. In some embodiments, the hyperparameter αₘ set by the user may be a variable that determines the size of the perturbation and may be predetermined for each column. In such an embodiment, the hyperparameter αₘ may be independently determined for each column by the random sampling from the normal distribution.

Thereafter, the apparatus 100 for augmenting a dataset may store the augmented dataset in a database or transmit the augmented dataset to the AI model through a communication device (S140). The augmented dataset stored in the database may be provided to the AI model as an input of the augmented dataset or as an input pair of the original dataset and the augmented dataset.

As described above, the apparatus 100 for augmenting a dataset according to one or more embodiments may augment the dataset to have a data distribution similar to the original dataset by adding the perturbation determined through the component analysis of the tabular original dataset to the original dataset, so the semantic of the original tabular dataset may be maintained in the augmented dataset.

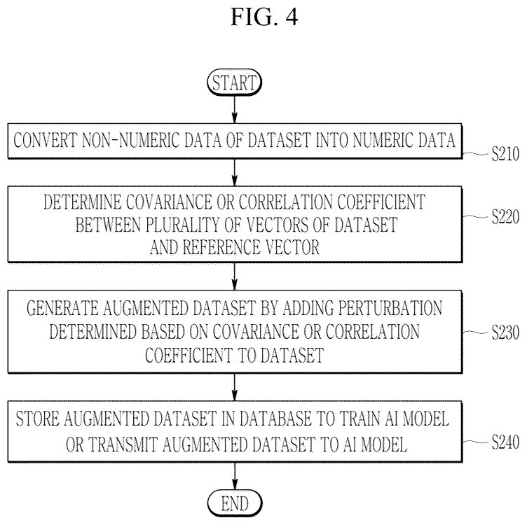

FIG. 4 illustrates a method for augmenting a dataset according to another embodiment.

Referring to FIG. 4, the data preprocessor 110 of the apparatus 100 for augmenting a dataset may convert non-numeric data included in the original dataset into numeric data (S210). For example, values such as names of specific pieces of equipment may be converted to unique numeric identifiers. When the original dataset does not include non-numeric data the original dataset may be provided directly to the component analyzer 120.

In some embodiments, the component analyzer 120 of the apparatus 100 for augmenting data may determine a covariance and/or correlation coefficient between a reference vector and the vectors (e.g., columns, or rows) included in the original dataset (S220). Here, the correlation coefficient may be a learnable parameter that may be learned to fit an objective function through a graph neural network and/or a self-attention mechanism, etc.

The component analyzer 120 may determine the covariance or correlation coefficient between a reference row vector and N row vectors that have data of each row of the original dataset as elements. The component analyzer 120 may randomly determine one row vector, among the row vectors, as the reference row vector or may determine the reference row vector through statistical processing (e.g., average of dimensions of corresponding elements within the row vector) on the row vectors in the original dataset.

In some embodiments, the perturbation adder 130 of the apparatus 100 for augmenting a dataset may generate the augmented dataset by adding the perturbation determined based on the covariance or correlation coefficient to the dataset (S230).

The perturbation adder 130 may augment the original dataset by scaling the covariance or correlation coefficient using a hyperparameter βₙ and adding the scaled covariance or correlation coefficient as the perturbation to the vectors (e.g., column vectors) of the original dataset. Equation 7 below represents the m-th column Cₘ′ of the augmented dataset generated based on the reference row vector and the covariance between the row vectors included in the original dataset.

$${C}_{m}^{′} = {C}_{m} + [ {β}_{m} {σ}_{1 , ref} , … , {β}_{m} {σ}_{n , ref} , … , {β}_{m} {σ}_{N , ref} ] \qquad Equation 7$$

In Equation 7, σ_{n,ref} represents a covariance between an n-th row vector Rₙ and a reference row vector R_{ref}. A hyperparameter βₘ is a variable that determines the size of the perturbation and may be predetermined for each column. In such an embodiment, the hyperparameter βₘ may be independently determined for each column by the random sampling from the normal distribution.

Equation 8 below represents the m-th column Cₘ′ of the augmented dataset based on the correlation coefficient between the reference row vector and the plurality of row vectors included in the original dataset.

$${C}_{m}^{′} = {C}_{m} + [ {β}_{m} {ρ}_{1 , ref} , … , {β}_{m} {ρ}_{n , ref} , … , {β}_{m} {ρ}_{N , ref} ] \qquad Equation 8$$

In Equation 8, ρ_{n,ref} represents a correlation coefficient between the n-th row vector Rₙ and the reference row vector R_{ref}. The hyperparameter βₘ is a variable that determines the size of the perturbation and may be predetermined for each column (for example, a user may set the hyperparameters of different columns to reflect the columns that are important to the user). The hyperparameter βₘ may be independently determined for each column by the random sampling from the normal distribution.

In some embodiments, the apparatus 100 for augmenting a dataset may store the augmented dataset in a database or transmit the augmented dataset to the AI model through a communication device (S240). The augmented dataset stored in the database may be provided to the AI model as an input of the augmented dataset or as an input paired with the original dataset.

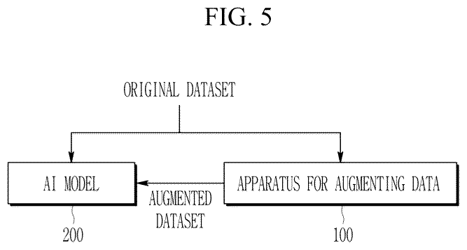

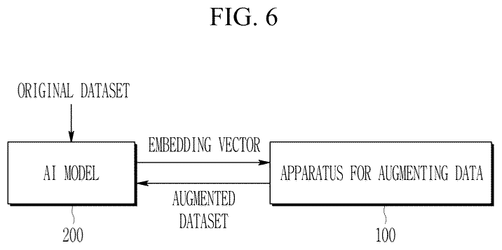

FIG. 5 illustrates a system for training an AI model according to one or more embodiments. FIG. 6 illustrates a system for training an AI model according to another embodiment.

Referring to FIG. 5, the original dataset may be input to the apparatus 100 for augmenting a dataset and the AI model 200, and the apparatus 100 for augmenting a dataset may augment the original dataset to generate the augmented dataset.

The original dataset may include only numeric data or both non-numeric data and numeric data. The data preprocessor of the apparatus 100 for augmenting data may convert any non-numeric data included in the original dataset into numeric data.

In some embodiments, the apparatus 100 for augmenting a dataset may determine a correlation between the vectors included in the original dataset and determine the perturbation based on the correlation between the vectors. The apparatus 100 for augmenting a dataset may add the perturbation to the original dataset to generate the augmented dataset, which has the same semantic as the original dataset. The apparatus 100 for augmenting a dataset may generate multiple augmented datasets from one original dataset, for example, using different hyperparameters for different respective augmented datasets, using row-wise augmentation for one dataset and column-wise augmentation for another dataset, etc.

In some embodiments, the AI model 200 may perform supervised learning using a pairing of the original dataset and the augmented dataset, with the augment dataset being labeled identically to the original dataset. When there is a lack of training data for a specific class (e.g., a lack of data indicating a specific defect), the AI model 200 may use the augmented dataset to increase learning performance for the specific class.

Alternatively, the AI model 200 may perform self-supervised learning based on the input pair of the original dataset and at least one augmented dataset. As a non-limiting example, an embedding layer, an encoder, and a projection head of the AI model 200 may use the output inferred by the AI model 200 from the original dataset and the output inferred by the AI model 200 from the at least one augmented dataset to calculate a loss function. In such an embodiment, the AI model 200 may perform the self-supervised learning by updating the embedding layer, the encoder, and the projection head based on the loss function calculated from the output inferred from the original dataset and the output inferred from the at least one augmented dataset. The loss-based training may be used with any of the techniques described herein for generating an augmented dataset.

Referring to FIG. 6, when the original dataset is input to the AI model 200, the AI model 200 may generate an embedding vector from the original dataset and transmit the embedding vector generated by the embedding layers to the apparatus 100 for augmenting a dataset. The original dataset may include both non-numeric data and the numeric data.

In some embodiments, when each row of the original dataset includes both non-numeric data and numeric data, the embedding layer of the AI model 200 may convert both the non-numeric data and numeric data included within the original dataset into the embedding vector.

Equation 9 below represents an embedding vector ρₙₗ corresponding to an n-th row xₙ of the original dataset, generated by the embedding layer E.

$${p}_{n} = [ {p}_{n 1} , ... , {p}_{nl} , ... , {p}_{nL} ] = E ( {x}_{n} ) \qquad Equation 9$$

In Equation 9, 1<=l<=L represents the dimension of the embedding; dimension L is an arbitrary value. An embedding layer of the AI model 200 may generate an embedding vector pₙ corresponding to each row xₙ of the original dataset (i.e., the rows have respective embedding vectors) by mapping the data of each row xₙ of the original dataset into a latent space. When xₙ is a 1×M vector, the embedding vector pₙ may be a 1×M×L vector.

To summarize, the embedding layer of the AI model 200 may generate a 3D embedding vector p corresponding to the row vectors of all rows of the original dataset.

In some embodiments, the apparatus 100 for augmenting a dataset may determine a correlation between the vectors included in the embedding vector transmitted from the AI model 200. When the embedding vector p (which corresponds to the original dataset) converted by the embedding layer of the AI model 200 has N×M×L dimensions and when L is the embedding dimension, the apparatus 100 for augmenting a dataset may generate an N×M×L dimension augmented dataset.

In some embodiments, the apparatus 100 for augmenting a dataset may determine a covariance matrix using the N×M dimensional vector, and repeat the calculation of the covariance matrix, the eigenvector, and the eigenvalue for L times. For example, the apparatus 100 for augmenting a dataset may determine the covariance matrix between M vectors (of dimension 1×N) included in L vectors (of N×M dimension) and determine the eigenvector and eigenvalue from the covariance matrix.

The apparatus 100 for augmenting a dataset may calculate an eigenvector and an eigenvalue of an l-th covariance matrix generated based on M column vectors included in an l-th embedding vector (l is a random natural number between 1 and L) of the N×M dimension. Equations 10 and 11 below represent the eigenvector and eigenvalue, respectively, of the l-th covariance matrix calculated from the l-th embedding vector of the N×M dimension.

$${v}_{l} = [ {v}_{l 1} , … , {v}_{lM} ] \qquad Equation 10$$

$${λ}_{l} = [ {λ}_{l 1} , … , {λ}_{lM} ] \qquad Equation 11$$

In some embodiments, the apparatus 100 for augmenting a dataset may generate the augmented dataset by (i) determining a perturbation based on the eigenvector and eigenvalue determined through component analysis of the l-th N×M dimensional embedding vector and (ii) adding the perturbation to the embedding matrix. Equation 12 below represents the n-th row pₙₗ′ of the augmented dataset.

$${p}_{nl}^{′} = {p}_{nl} + {[ {v}_{l 1} , … , {v}_{lM} ] [ {γ}_{nl} {λ}_{l 1} , … , {γ}_{nl} {λ}_{lM} ]}^{T} \qquad Equation 12$$

Referring to Equation 12, the apparatus 100 for augmenting a dataset may scale the eigenvector using a hyperparameter γₙₗ and the eigenvalue and add the scaled eigenvector as the perturbation to each row of the embedding matrix in order to augment the original dataset. The hyperparameter γₙₗ may be a variable that determines the size of the perturbation and may be predetermined for each row of the embedding matrix. In such an embodiment, the hyperparameter γₙₗ may be independently determined for each row by the random sampling from the normal distribution.

In some embodiments, the apparatus 100 for augmenting a dataset may transmit the augmented dataset (dimension N×M×L) to the AI model 200, and the AI model 200 may perform training using the augmented dataset. In some embodiments, rows in the augmented dataset, i.e., rows that are augmented versions of rows in the original dataset, may have same ground-truth labels (e.g., defective/non-defective, actual yield, an equipment/step responsible for defect, etc.) as their original versions in the original dataset, and losses between predictions (e.g., prediction of defective, predicted yield, etc.) by the AI model 200, of the augmented rows and their ground truth labels may be used to update parameter(s) of the AI model 200 (e.g., weights, biases, etc.) to reduce the losses.

In another embodiment, the AI model 200 may perform the self-supervised learning based on the input pair of the original dataset and at least one augmented dataset. For example, the encoder and the projection head of the AI model 200 may use the output from the original dataset and the output from at least one augmented dataset to calculate the loss function. In such an embodiment, the AI model 200 may perform the self-supervised learning by updating the embedding layer, the encoder, and the projection head based on the calculation results of the loss function using the output from the original dataset and the output from at least one augmented dataset.

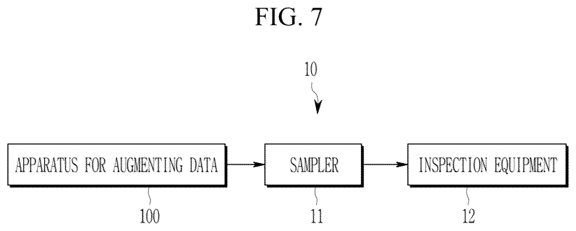

FIG. 7 illustrates a system for inspecting a semiconductor manufacturing process according to one or more embodiments.

Referring to FIG. 7, a system for inspecting a semiconductor manufacturing process 10 may include a sampler 11 and an inspection device 12. The sampler 11 may perform sampling for inspection and/or metrology of semiconductor products that have been manufactured or is being manufactured. In some embodiments, the sampler 11 may sample (obtain data analogous to the dataset(s)) at least one LOT (among LOTs) or may sample data of at least one semiconductor wafer (among semiconductor wafers), and the inspection device 12 perform an inspection on the sampled LOT and/or semiconductor wafer.

Full inspection of all the LOTs and/or semiconductor wafers is not generally practical due to capacity limitations of the inspection device 12. Therefore, conventionally, a LOT or semiconductor wafer may be sampled based on an engineer's determination or predetermined rules. In this case, when a defect occurs in non-inspected LOTs or wafers, losses may occur and costs may increase in the subsequent manufacturing process.

The semiconductor manufacturing process requires metrology and inspection, but since the metrology/inspection consumes significant time and money, it is difficult to conduct full inspection. To this end, after the sensor/event data occurring during the semiconductor manufacturing process is analyzed by the trained AI model, the sampling may be performed to improve the metrology/inspection efficiency (i.e., metrology/inspection may be targeted where defects are more likely to occur). Much sensor/event data of the defective semiconductor/wafer is required to train the AI model, but through the process optimization, defects gradually decrease, and as a result, defective data is becomes scarce, making it difficult to train the AI model.

In some embodiments, the sampler 11 may sample (AI-based sample) LOTs or semiconductor wafers with a high probability of defects using the AI model trained based on the sensor data and event data generated in the semiconductor manufacturing process. For the training of the AI model used for the AI-based sampling of the sampler 11, the apparatus 100 for augmenting a dataset may augment data of classes with insufficient samples (relatively low numbers of samples) in the sensor data and event data generated in the semiconductor manufacturing process and provide the augmented data to the sampler 11. For example, in a real industrial environment such as the semiconductor manufacturing process, when there are many normal samples and very few defective samples (e.g. imbalanced class, 99.95%:0.05%), in order for the AI model to train the class despite the insufficient samples, the apparatus 100 for augmenting data may augment the data of the corresponding class and provide the augmented data to the AI model to provide sufficient training samples.

In some embodiments, the apparatus 100 for augmenting a dataset may generate at least one augmented dataset from an original dataset, and provide the input pair of the original dataset and the augmented dataset labeled identically to the original dataset to the sampler 11. At least one augmented dataset (e.g., ground-truth labeled) may be usefully used in the supervised learning of the AI model, and the input pair of the original dataset and at least one augmented dataset (e.g., unlabeled) may also be usefully used in the self-supervised learning of the AI model.

As described above, the apparatus 100 for augmenting a dataset may provide to the AI model the tabular dataset (e.g., a matrix/tensor, a data volume, etc.) with the same semantic as the original dataset so that the AI model of the sampler 11 may successfully perform the supervised learning and the self-supervised learning with sufficient training samples. Accordingly, the sampler 11 may perform the AI-based sampling using the AI model trained based on the data augmented by the apparatus 100 for augmenting a dataset, thereby improving the sampling accuracy for the LOTs or semiconductor wafers with a high probability of defects, for example.

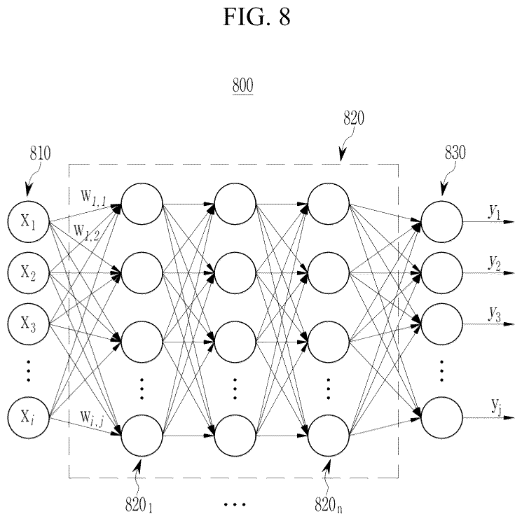

FIG. 8 illustrates a neural network according to one or more embodiments.

Referring to FIG. 8, a neural network 800 according to one or more embodiments may include an input layer 810, a hidden layer 820, and an output layer 830. Each of the input layer 810, the hidden layer 820 (representative of one or more hidden layers), and the output layer 830 may include a respective set of nodes, and a strength of connections between nodes may correspond to weight value. This may be referred to as connection weight. The set of nodes included in each of the input layer 810, the hidden layer 820, and the output layer 830 may be fully connected to each other, or less than fully connected. In some embodiments, the number of parameters (weight values and bias values) may be equal to the number of connections within the neural network 800.

The input layer 810 may include a set of input nodes x₁ to xᵢ, and the number of input nodes x₁ to xᵢ may correspond to the number of independent input variables (e.g., the number of elements in an original or augmented dataset). For training the neural network 800, a training set may be input to the input layer 810, and if a test dataset is input to the input layer 810 of the trained neural network 800, an inference result (e.g., predicted contributions of respective elements) may be output from the output layer 830 of the trained neural network 800. In some embodiments, the input layer 810 may have a structure suitable for processing large-scale inputs.

The hidden layer 820 may be disposed between the input layer 810 and the output layer 830, and may include at least one of hidden layer or 820₁ to 820ₙ hidden layers. The output layer 830 may include at least one of output node or y₁ to yⱼ output nodes. An activation function may be used in the hidden layer(s) 820 and the output layer 830. In some embodiments, the neural network 800 may be learned by adjusting weight values of a hidden nodes included in the hidden layer(s) 820.

Although some description above includes mathematical notation, the embodiments described herein are not directed to mathematics per se. Rather, the mathematical notation and equations describe how an engineer may configure source code that may be compiled into executable code that may cause physical processor(s) to operate in ways that parallel the mathematical description. Although the information in the mathematical description could be provided in text form, such description would be verbose and difficult to understand. In short, the mathematical description is simply concise description of how to construct physical objects (e.g., memory storing instructions) that can implement the embodiments and examples described herein.

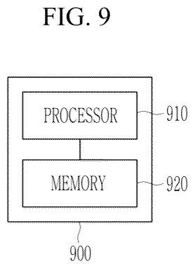

FIG. 9 illustrates an apparatus for augmenting data according to another embodiment.

An apparatus for analyzing a yield of a wafer according to one or more embodiments may be implemented as a computer system (for example, a computer-readable medium). Referring to FIG. 9, the computer system 900 includes one or more processors 910 and a memory 920. The one or more processors 910 is representative of any single processor or any combination of processors, e.g., a CPU, a GPU, an NPU, an accelerator, etc. The memory 920 may be connected to the one or more processors 910 and may store instructions or programs configured to cause the one or more processors 910 to perform a process including any of the methods described above.

The one or more processors 910 may realize functions, stages, or methods proposed in the embodiment. An operation of the computer system 900 according to one or more embodiments may be realized by the one or more processors 910. The one or more processors 910 may include a GPU, a CPU, and/or an NPU. When the operation of the computer system 900 is implemented by the one or more processors 910, each task may be divided among the one or more processors 910 according to load. For example, when one processor is a CPU, the other processors may be a GPU, an NPU, an FPGA, and/or a DSP.

The memory 920 may be provided inside/outside the processor, and may be connected to the processor through various means known to a person skilled in the art. The memory represents a volatile or non-volatile storage medium in various forms (but not a signal per se), and for example, the memory may include a read-only memory (ROM) and a random-access memory (RAM). In another way, the memory may be a PIM (processing in memory) including a logic unit for performing self-contained operations.

In another way, some functions (e.g., training the yield predicting model and/or the path generating model, inference by the yield predicting model and/or the path generating model) of the yield predicting device may be provided by a neuromorphic chip including neurons, synapses, and inter-neuron connection modules. The neuromorphic chip is a computer device simulating biological neural system structures, and may perform neural network operations.

Meanwhile, the embodiments are not only implemented through the device and/or the method described so far, but may also be implemented through a program that realizes the function corresponding to the configuration of the embodiment or a recording medium on which the program is recorded, and such implementation may be easily implemented by anyone skilled in the art to which this description belongs from the description provided above. Specifically, methods (e.g., yield predicting methods, etc.) according to the present disclosure may be implemented in the form of program instructions that can be performed through various computer means. The computer readable medium may include program instructions, data files, data structures, etc. alone or in combination. The program instructions recorded on the computer readable medium may be specifically designed and configured for the embodiments. The computer readable recording medium may include a hardware device configured to store and execute program instructions. For example, a computer-readable recording medium includes magnetic media such as hard disks, floppy disks and magnetic tapes, optical recording media such as CD-ROMs and DVDs, and optical disks such as floppy disks. It may be magneto-optical media, ROM, RAM, flash memory, or the like. A program instruction may include not only machine language codes such as generated by a compiler, but also high-level language codes that may be executed by a computer through an interpreter or the like.

The computing apparatuses, the electronic devices, the processors, the memories, the displays, the information output system and hardware, the storage devices, and other apparatuses, devices, units, modules, and components described herein with respect to FIGS. 1-9 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-9 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A method for augmenting a dataset, the method performed by one or more processors and comprising:
determining a correlation between vectors included in the dataset;
determining perturbation based on the correlation; and
generating an augmented dataset by adding the perturbation to the dataset.

2. The method of claim 1, wherein:
the determining of the correlation between the vectors included in the dataset comprises
performing principal component analysis (PCA) or independent component analysis (ICA) on the vectors.

3. The method of claim 2, wherein:
the performing of the PCA or ICA on the vectors comprises:
determining a covariance matrix between column vectors included in the dataset; and
calculating an eigenvector and an eigenvalue of the covariance matrix.

4. The method of claim 3, wherein:
the determining of the perturbation based on the correlation comprises
determining perturbations respectively corresponding to rows of the dataset by scaling each element of the eigenvector using the eigenvalue and a hyperparameter.

5. The method of claim 4, wherein:
the hyperparameter is independently determined for each row of the dataset by random sampling from a normal distribution.

6. The method of claim 4, wherein:
the generating of the augmented dataset by adding the perturbation to the dataset comprises
adding the perturbations to the respective rows of the dataset.

7. The method of claim 1, further comprising:
converting non-numeric data included in the dataset into numeric data,
wherein the vectors include the numeric data.

8. The method of claim 1, wherein:
the determining of the correlation between the vectors included in the dataset comprises:
receiving a three-dimensional embedding vector generated by mapping data included in the dataset to a latent space; and
determining a correlation between vectors included in the three-dimensional embedding vector.

9. The method of claim 8, wherein:
the data included in the dataset includes numeric data and non-numeric data.

10. The method of claim 1, further comprising:
storing the augmented dataset in a database or transmitting the stored augmented data to an artificial intelligence (AI) model.

11. An apparatus for augmenting a dataset, the apparatus comprising:
one or more processors and a memory, wherein the memory stores instructions configured to cause the one or more processors to perform a process comprising:
determining a correlation between vectors included in the dataset; and
generating an augmented dataset by adding perturbation determined based on the correlation to the dataset.

12. The apparatus of claim 11, wherein:
the determining of the correlation between the vectors included in the dataset comprises
performing principal component analysis (PCA) or independent component analysis (ICA) on the plurality of vectors.

13. The apparatus of claim 12, wherein:
the performing of the PCA or ICA on the vectors comprises:
determining a covariance matrix between column vectors included in the dataset; and
calculating an eigenvector and an eigenvalue of the covariance matrix.

14. The apparatus of claim 13, wherein:
the generating of the augmented dataset by adding the perturbation determined based on the correlation to the dataset comprises
determining the perturbations respectively corresponding to rows of the dataset by scaling each element of the eigenvector using the eigenvalue and a hyperparameter.

15. The apparatus of claim 14, wherein:
the generating of the augmented dataset by adding the perturbation determined based on the correlation to the dataset comprises
adding the perturbations to the respective rows of the dataset.

16. The apparatus of claim 11, wherein:
the process further comprises:
converting non-numeric data included in the dataset into numeric data, wherein the plurality of vectors include the numeric data.

17. The apparatus of claim 11, wherein:
the determining of the correlation between the vectors included in the dataset comprises:
receiving, from an artificial intelligence (AI) model, a three-dimensional embedding vector generated by mapping the data included in the dataset to a latent space; and
determining a correlation between vectors included in the three-dimensional embedding vector.

18. The apparatus of claim 17, wherein:
the data included in the dataset includes both numeric data and non-numeric data.

19. The apparatus of claim 17, wherein:
the process further comprising
transmitting the augmented dataset to the AI model which performs an inference on the augmented dataset.

20. A system for inspecting a semiconductor manufacturing process, the system comprising:
a sampler that samples a semiconductor wafer for inspection of semiconductor manufacturing process using an artificial intelligence (AI) model; and
an inspection device that performs measurement on the semiconductor wafer sampled by the sampler,
wherein the AI model is trained through self-supervised learning based on an input pair of an original dataset and a dataset labeled identically to the original dataset.
